(19) United States
(12) Patent Application Publication
(10) Pub. No.: US 2023/0115028 A1
(43) Pub. Date: Apr. 13, 2023

(54) Automated Avatars

(71) Applicant: Meta Platforms Technologies, LLC, Menlo Park, CA (US)

(72) Inventor: Amrutha Hakkare ARUNACHALA, Sunnyvale, CA (US)

(21) Appl. No.: 17/498,261

(22) Filed: Oct. 11, 2021

(51) Int. Cl. G06T 11/00; G06K 9/00; G06F 40/279; G06F 16/23; G06N 20/00

(52) U.S. Cl. CPC G06T 11/00; G06K 9/00362; G06F 40/279; G06F 16/2365; G06N 20/00

(57) ABSTRACT

An automatic avatar system can build a custom avatar with features extracted from one or more sources. The automatic avatar system can identify such features in a source image of a user, from an online context source of the user (e.g., shopping activity, social media activity, messaging activity, etc.), and/or from a user-provided textual description source describing one or more avatar features. The automatic avatar system can query an avatar library for the identified avatar features. In some cases, the automatic avatar system may identify multiple options for the same avatar feature from the various sources and the automatic avatar system can select which of the features to use based on a priority order specified among the sources or by providing the multiple options to the user for selection. Once the avatar features are obtained, the automatic avatar system can combine them to build the custom avatar.

### TECHNICAL FIELD

The present disclosure is directed to generating an avatar using avatar features automatically selected from sources such as an image of a user, an online context of a user, and/or a textual description of avatar features.

### BACKGROUND

Avatars are a graphical representation of a user, which may represent the user in an artificial reality environment, on a social network, on a messaging platform, in a game, in a 3D environment, etc. In various systems, users can control avatars, e.g., using game controllers, keyboards, etc., or a computing system can monitor movements of the user and can cause the avatar to mimic the user's movements. Often, users can customize their avatar, such as by selecting body and facial features, adding clothing and accessories, setting hairstyles, etc. Typically, these avatar customizations are based on a user viewing categories of avatar features in an avatar library and, for some further customizable features, setting characteristics for these features such as a size or color. The selected avatar features are then cobbled together to create a user avatar.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a flow diagram illustrating a process used in some implementations of the present technology for automatically generating an avatar based on features extracted from one or more sources.

FIG. 6 is a flow diagram illustrating a process used in some implementations of the present technology for extracting avatar features based on an image source.

FIG. 7 is a flow diagram illustrating a process used in some implementations of the present technology for extracting avatar features based on an online context source.

FIG. 8 is a flow diagram illustrating a process used in some implementations of the present technology for extracting avatar features based on a textual source.

FIGS. 9A-9C are conceptual diagrams illustrating examples of user interfaces and results of automatic avatar creation based on an image.

FIG. 10 is a conceptual diagram illustrating an example of automatic avatar creation based on an online context.

FIG. 11 is a conceptual diagram illustrating an example of automatic avatar creation based on text.

FIG. 12 is a system diagram illustrating an example system for automatically creating an avatar from an image, context, and text.

The techniques introduced here may be better understood by referring to the following Detailed Description in conjunction with the accompanying drawings, in which like reference numerals indicate identical or functionally similar elements.

### DETAILED DESCRIPTION

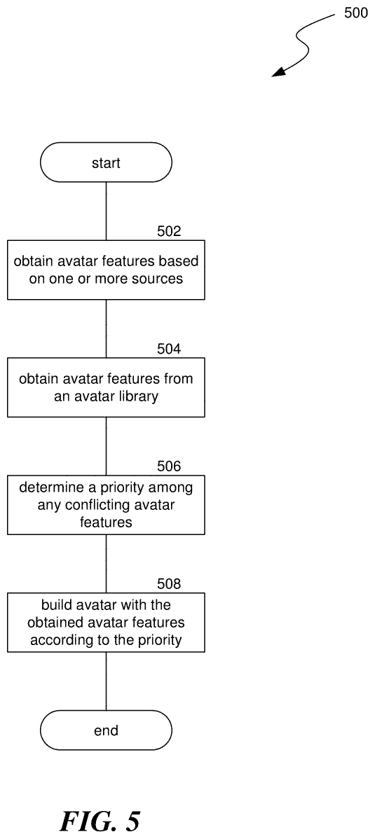

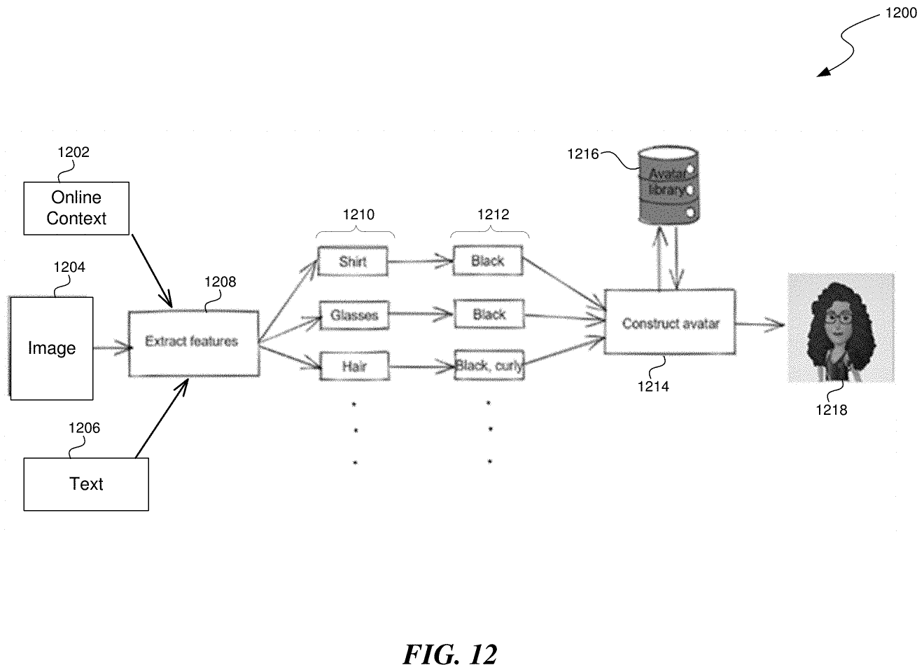

Aspects of the present disclosure are directed to an automatic avatar system that can build a custom avatar with features matching features identified in one or more sources. The automatic avatar system can identify such matching features in an image of a user, from an online context of the user (e.g., shopping activity, social media activity, messaging activity, etc.), and/or a textual/audio description of one or more avatar features provided by the user. The automatic avatar system can then query an avatar library for the identified avatar features. Where needed avatar features are not included in the results from the avatar library, the automatic avatar system can use general default avatar features or default avatar features previously selected by the user. In some cases, the automatic avatar system may identify multiple options for the same avatar feature from the various sources and the automatic avatar system can select which of the features to use based on a priority order specified among the sources or by providing the multiple options to the user for selection. Once the avatar features are obtained, the automatic avatar system can combine them to build the custom avatar. Additional details on obtaining avatar features and building an avatar are provided below in relation to FIGS. 5 and 12.

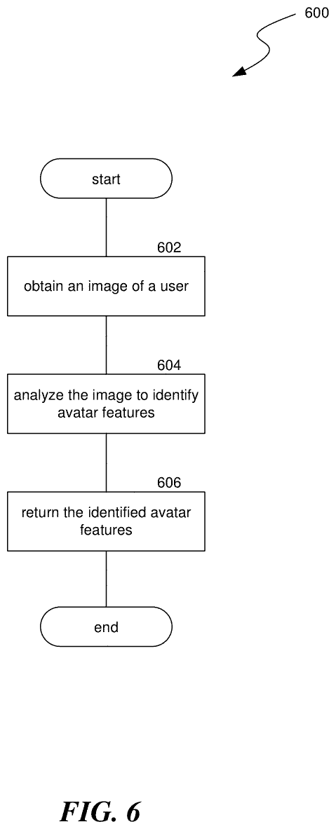

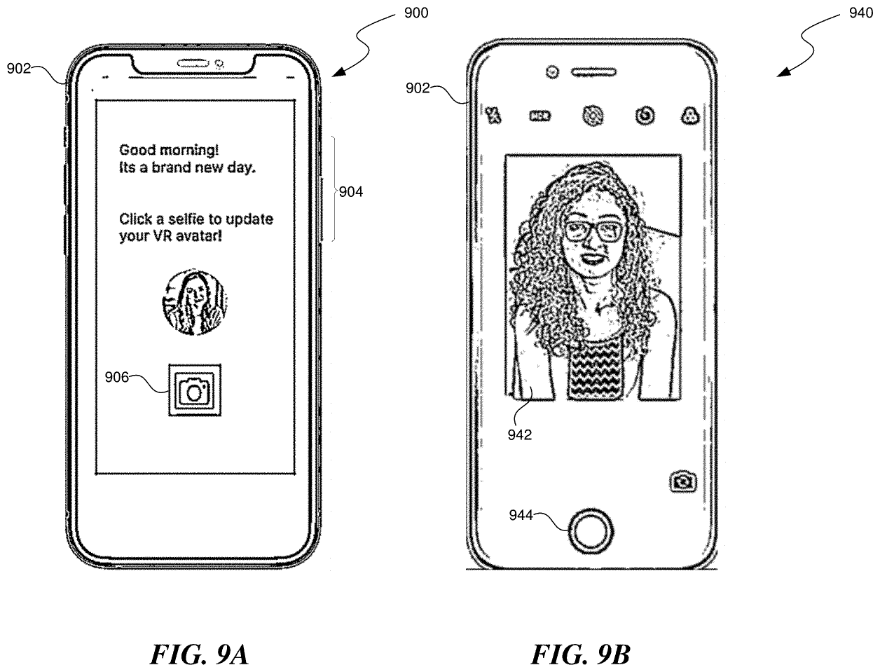

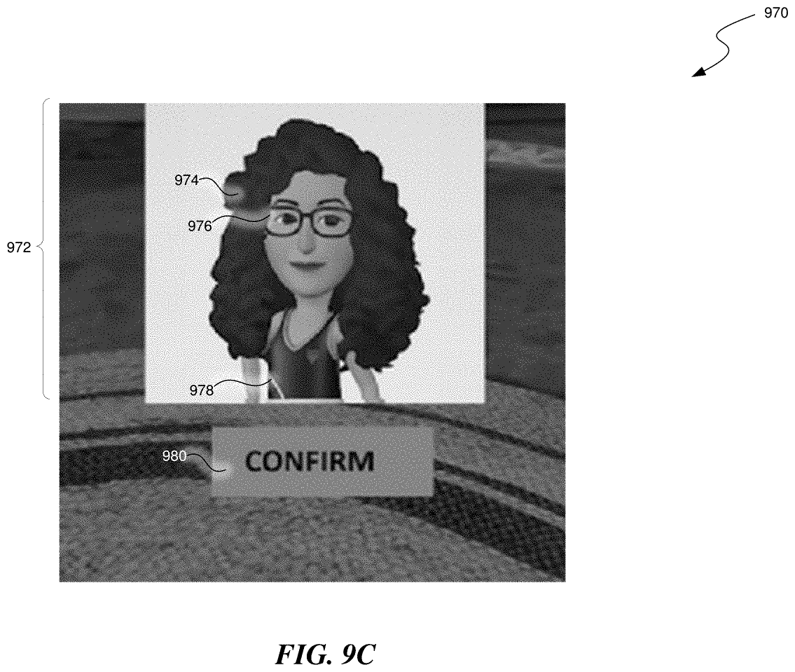

The automatic avatar system can identify avatar features from an image by applying one or more machine learning models, to the image, trained to produce semantic identifiers for avatar features such as hair types, facial features, body features, clothing/accessory identifiers, feature characteristics such as color, shape, size, brand, etc. For example, the machine learning model can be trained to identify avatar features of types that match avatar features in a defined avatar feature library. In some implementations, such machine learning models can be generic object recognition models where the results are then filtered for recognitions that match the avatar features defined in the avatar feature library or the machine learning model can be specifically trained to identify avatar features defined in the avatar feature library. Additional details on identifying avatar features from an image are provided below in relation to FIGS. 6 and 9.

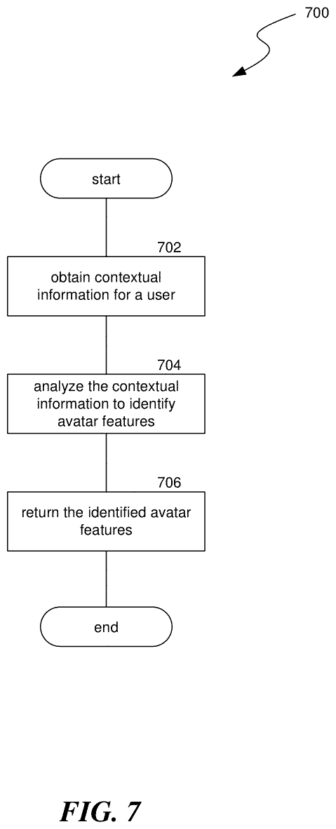

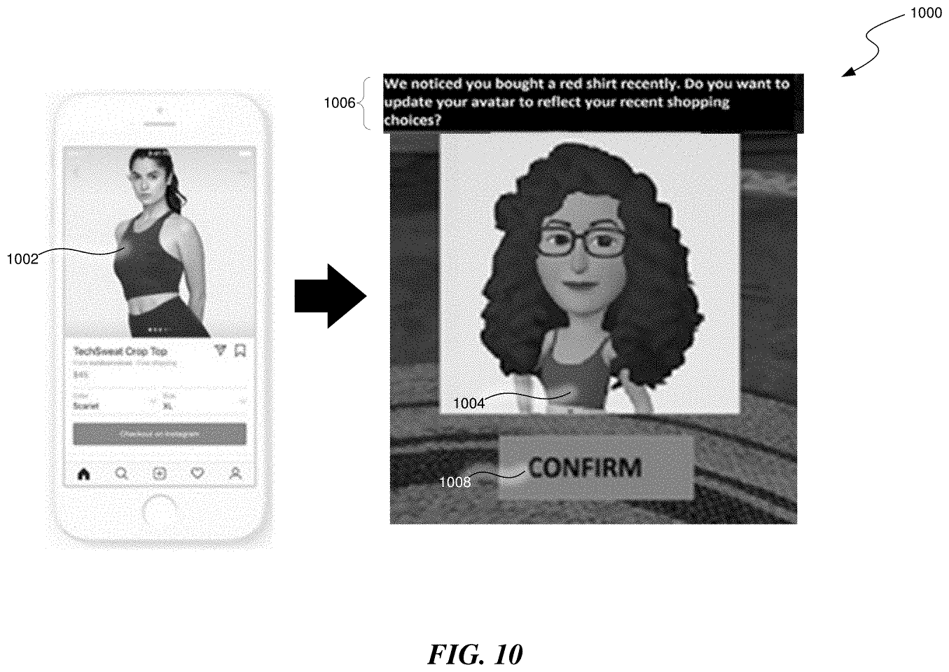

The automatic avatar system can identify avatar features from a user's online context by obtaining details of a user's online activities such as shopping items, social media “likes” and posts, event RSVPs, location check-ins, etc. These types of activities can each be mapped to a process to extract corresponding avatar features. For example, a shopping item can be mapped to selecting a picture of the purchased item and finding a closest match avatar feature in the avatar library; an event RSVP can be mapped to selecting accessories matching the event (e.g., pulling a sports cap matching a team for an RSVP to a sporting event); a like on a social media post can be mapped to extracting features of the persons depicted (e.g., matching makeup style) and/or to extracting objects depicted (e.g., selecting an avatar feature from the avatar library best matching a depicted pair of shoes in a social media post); etc. Additional details on identifying avatar features from an online context are provided below in relation to FIGS. 7 and 10.

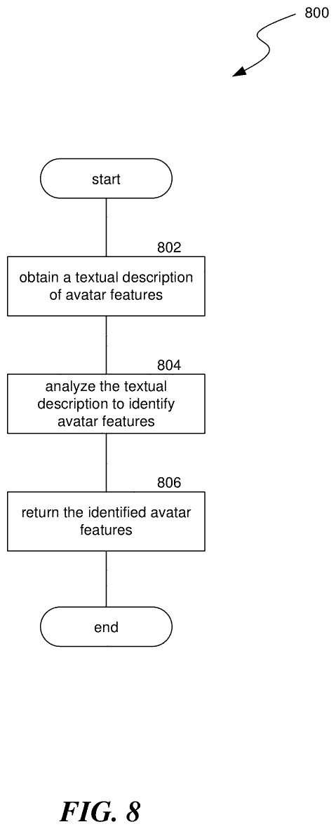

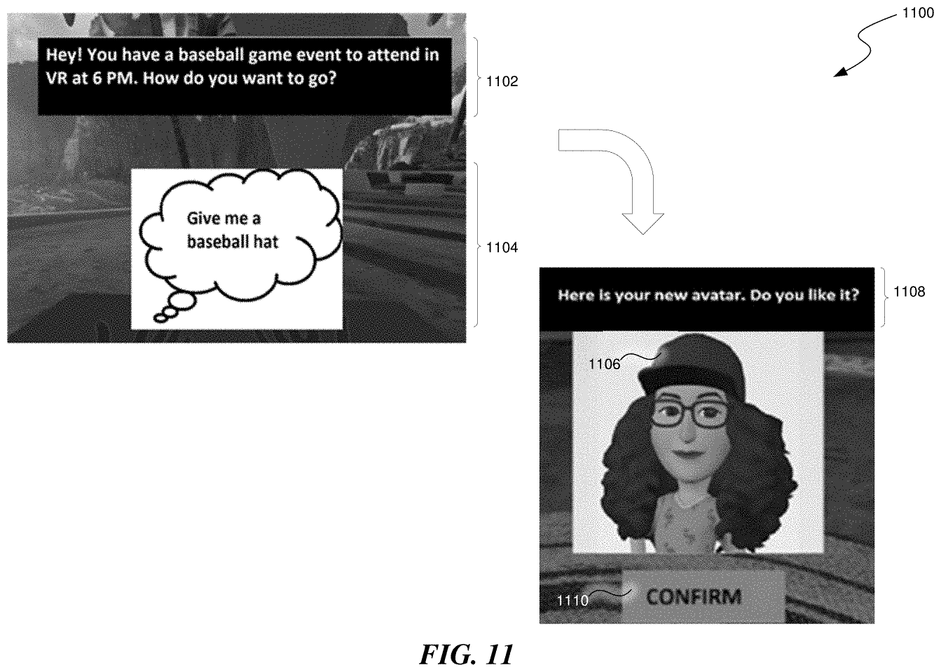

The automatic avatar system can identify avatar features from a user-provided description of an avatar by applying natural language processing (NLP) models and techniques to a user-supplied textual description of one or more avatar features (e.g., supplied in textual form or spoken and then transcribed). This can include applying machine learning models trained and/or algorithms configured to, e.g., perform parts-of-speech tagging and identify n-grams that correspond to avatar features defined in the avatar library. For example, the automatic avatar system can identify certain nouns or noun phrases corresponding to avatar features such as hair, shirt, hat, etc. and can identify modifying phrases such as big, cowboy, blue, curly, etc. and can select an avatar feature best matching the phrase, setting characteristics matching the modifying phrase. Additional details on identifying avatar features from a user-provided description of an avatar are provided below in relation to FIGS. 8 and 11.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

Typical systems that provide a representation of the system's users provide a single avatar per person, which a user may be able to manually reconfigure. However, people change clothes, accessories, styles (e.g., beard, no beard, hair color, etc.) quite often. Yet people generally do not want to make the effort to perform corresponding changes to their avatar, as doing so takes too much time. Thus, while there are existing systems for users to select avatar features, resulting in “personalized” avatars, these avatars tend to drift away from accurately representing the user as the user changes their style, clothes, etc. In addition, existing personalization systems are time-consuming to operate, often requiring the user to proceed through many selection screens. The automatic avatar system and processes described herein overcome these problems associated with conventional avatar personalization techniques and are expected to generate personalized avatars that are quick and easy to create while accurately representing the user or the user's intended look. In particular, the automatic avatar system can automatically identify avatar characteristics based on user-supplied sources such as images, online context, and/or text. From these, the automatic avatar system can rank results and generate suggested avatar features, allowing a user to keep their avatar fresh and consistent with the user's current style, without requiring a significant user investment of effort. In addition, instead of being an analog of existing techniques for manual creation of avatars, the automatic avatar system and processes described herein are rooted in computerized machine learning and artificial reality techniques. For example, the existing avatar personalization techniques rely on user manual selection to continuously customize an avatar, whereas the automatic avatar system provides multiple avenues (e.g., user images, online context, and textual descriptions) for automatically identifying avatar features.

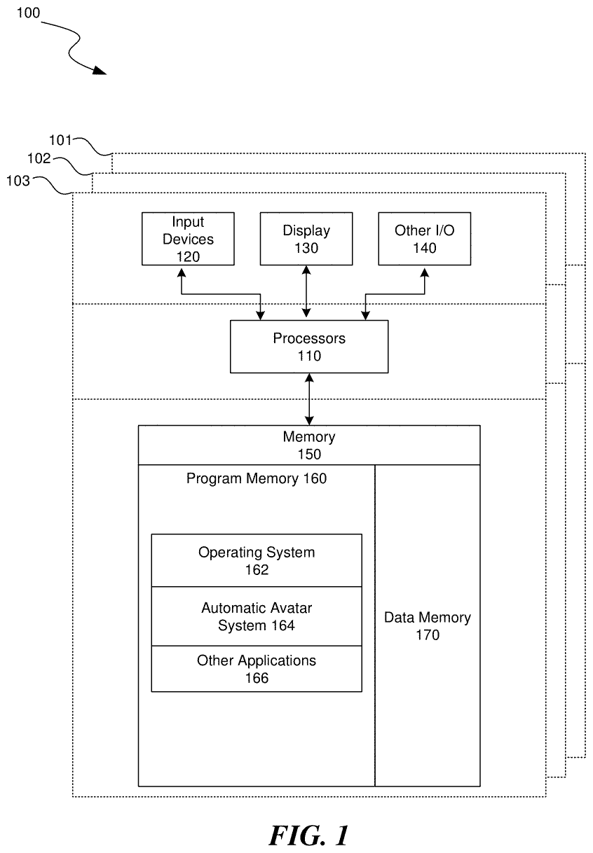

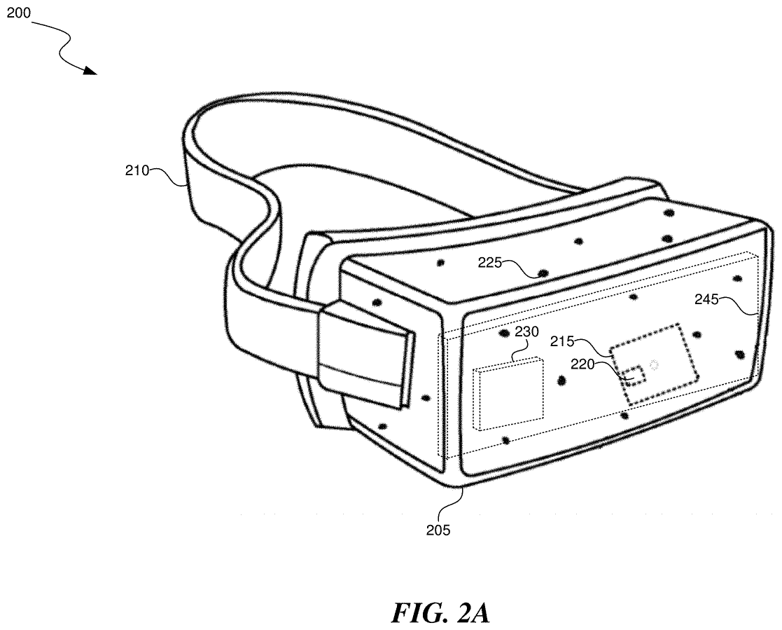

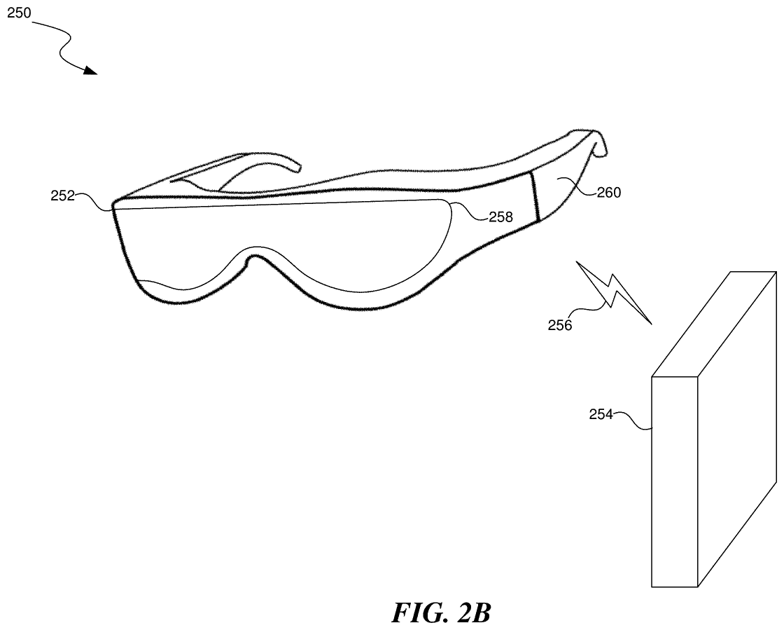

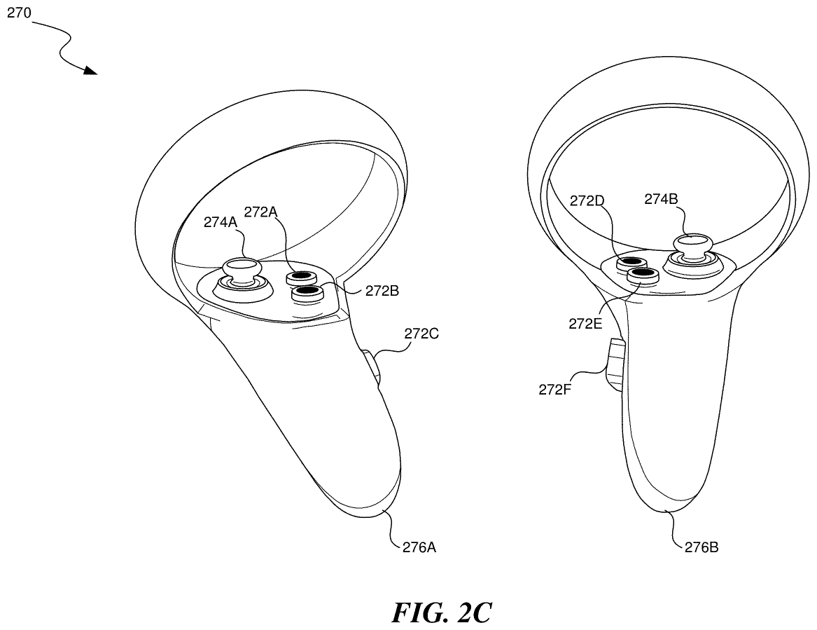

Several implementations are discussed below in more detail in reference to the figures. FIG. 1 is a block diagram illustrating an overview of devices on which some implementations of the disclosed technology can operate. The devices can comprise hardware components of a computing system 100 that generate an avatar using automatically selected avatar features based on sources such as an image of a user, an online context of a user, and/or a textual description of avatar features. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, girds, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, automatic avatar system 164, and other application programs 166. Memory 150 can also include data memory 170 that can include avatar features libraries, user images, online activities, textual avatar descriptions, machine learning models trained to extract avatar identifiers from various sources, mappings for identifying features to match with avatar features from social medial sources, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in an artificial reality environment in three degrees of freedom (3DoF) or six degrees of freedom (6DoF). For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270, which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

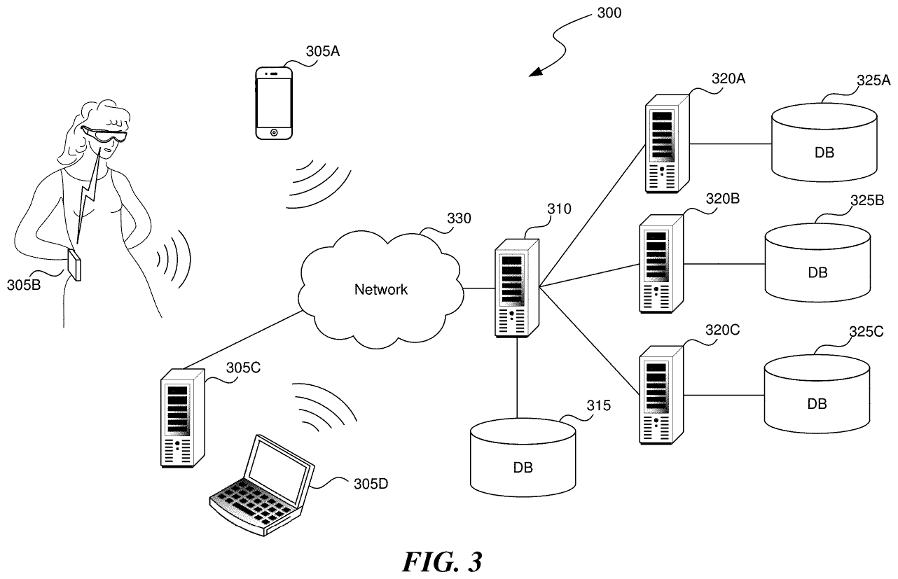

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

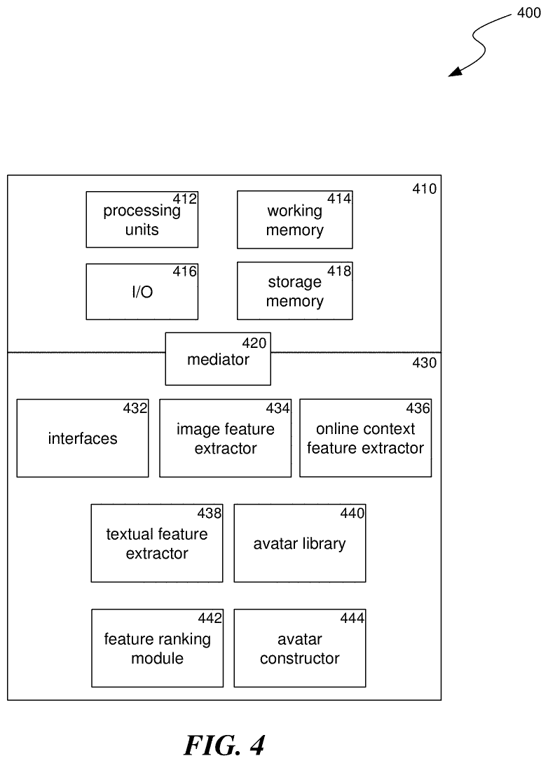

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for generating an avatar using automatically selected avatar features based on sources such as an image of a user, a context of a user, and/or a textual description of avatar features. Specialized components 430 can include image feature extractor 434, online context feature extractor 436, textual feature extractor 438, avatar library 440, feature ranking module 442, avatar constructor 444, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

Image feature extractor 434 can receive an image of a user and can identify semantic identifiers that can be used to select avatar features from avatar library 440. Image feature extractor 434 can accomplish this by applying one or more machine learning modules, to the image of the user, trained to produce the semantic identifiers. Additional details on extracting avatar features from an image are provided below in relation to FIG. 6.

Online context feature extractor 436 can receive data on a user's online activity (e.g., by a user authorizing this data's use for avatar selection) and can identify semantic identifiers that can be used to select avatar features from avatar library 440. Online context feature extractor 436 can accomplish this by applying a selection criteria defined for the type of the online activity, where the selection criteria defines one or more algorithms, machine learning models, etc., that take data generated by that type of online activity and produce one or more semantic identifiers. Additional details on extracting avatar features from an online context are provided below in relation to FIG. 7.

Textual feature extractor 438 can receive a textual description of avatar features from a user (which may be provided as text or audio which is transcribed) and can identify semantic identifiers that can be used to select avatar features from avatar library 440. Textual feature extractor 438 can accomplish this by applying one or more natural language processing techniques to identify certain type of phrases (e.g., those that match avatar feature definitions) and modifying phrases (e.g., those that can be used to specify characteristics for the identified avatar feature phrases) to produce semantic identifiers. Additional details on extracting avatar features from a textual description are provided below in relation to FIG. 8.

Avatar library 440 can include an array of avatar features which can be combined to create an avatar. In some implementations, avatar library 440 can map the avatar features into a semantic space, providing for searching for avatar features by mapping sematic identifiers into the semantic space and returning the avatar features closest in the semantic space to the location of the semantic identifiers. In some implementations, avatar library 440 can receive textual semantic identifiers and can return avatar features with descriptions best matching the textual semantic identifiers. Additional details on an avatar library and selecting avatar features are provided below in relation to block 504 of FIG. 5.

Feature ranking module 442 can determine, when two or more selected avatar features cannot both be used in the same avatar, which to select. Feature ranking module 442 can accomplish this based on, e.g., a ranking among the sources of the avatar features, through user selections, based on confidence factors for the selected avatar features, etc. Additional details on ranking conflicting avatar features are provided below in relation to block 506 of FIG. 5.

Avatar constructor 444 can take avatar features, obtained from avatar library 440, and use them to construct an avatar. Additional details on constructing an avatar are provided below in relation to block 508 of FIG. 5.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5 is a flow diagram illustrating a process 500 used in some implementations of the present technology for automatically generating an avatar based on features extracted from one or more sources. In some implementations, process 500 can be performed when an XR device, mobile device, or other system is initialized (e.g., as a user enters an artificial reality environment), when a user first sets up the device, periodically (e.g., daily or weekly), in response to a user commend to enter an avatar customization process, etc. In various cases, process 500 can be performed on a device (e.g., artificial reality device, mobile phone, laptop, etc.) that supports user representations, or on a server system supporting such client devices.

At block 502, process 500 can obtain avatar features based on one or more sources (e.g., based on a user image, online context, and/or a textual avatar description). Process 500 can analyze the information from each of the one or more sources to find features (e.g., semantic identifiers) that match available types of avatar characteristics (e.g., hair, accessories, clothing options, etc.) in an avatar library. For example, a user can supply an image which can be analyzed for features such as a depicted hair style, depicted clothing, depicted accessories, depicted facial or body features, etc. Additional details on obtaining avatar features based on a user image are provided below in relation to FIG. 6. As another example, a user can authorize review of her online activity (“online context”) to select corresponding avatar features such as those closest to her purchased items, features common in social media posts she makes or “likes,” items corresponding to events she signals she has/will attend, items corresponding to location check-ins, etc. Additional details on obtaining avatar features based on an online context are provided below in relation to FIG. 7. As yet another example, a user can supply a natural language description of one or more avatar features (e.g., spoken or typed commands such as “put my avatar in a green hat”), which process 500 can analyze to match with avatar features in an avatar library. Additional details on obtaining avatar features based on a textual avatar description are provided below in relation to FIG. 8.

At block 504, process 500 can obtain the avatar features identified at block 502 from an avatar library. In some implementations, this can include determining a best match between semantic identifiers (e.g., “curly hair,” “square glasses,” “red tank-top”) and avatar features in the avatar library. For example, the avatar features can be mapped into a semantic space and, with a trained machine learning model, the semantic identifiers can be mapped into the semantic space to identify the closest matching (e.g., smallest co-sign distance) avatar feature. In some cases, the matching can be performed by comparing the semantic identifiers as textual descriptions to textual descriptions of the avatar features in the avatar library, using known textual comparison techniques.

In some implementations, a selected avatar feature can have characteristic options (e.g., size, style, color, etc.) that can be set based on the definition from the source identified at block 502. For example, if the source was identified as including a “blue tank top” a tank top avatar feature can be selected from the avatar library and can be set to display as blue (e.g., a generic “blue” or a particular blue matching a shade from a user-supplied image or online context source). In some cases, the avatar features specified from the one our more source may not include parts of an avatar deemed necessary, in which case process 500 can use default avatars features for these parts (e.g., generic feature, features known to match a type—such as gender, ethnicity, age, etc.—defined for the user, or feature specified by the user in a default avatar). In some cases, this can include using the selected avatar features to replace features in an existing avatar of the user.

At block 506, process 500 can determine a priority among conflicting avatar features obtained at block 502. In some cases, the avatar features obtained at block 504 cannot all be applied to a single avatar. For example, the avatar features could include black round glasses and red square glasses, and both cannot be put on the same avatar. For such conflicts, process 500 can apply a ranking system to select which avatar feature to use. In various implementations, this can include suggesting the multiple options to a user to select which to apply to the avatar, selecting the avatar feature corresponding to a highest ranked source (e.g., avatar features based on a text description may be ranked higher than those based on an image, which may in turn be ranked higher than those based on an online context). In some cases, process 500 may only select the avatar features from a single source (according to the source rankings) or may provide a version of an avatar corresponding to each source for the user to select among. For example, a user may provide an image which process 500 may use to build a first avatar and process 500 may determine an online context for the user, which process 500 may use to build a second avatar The user may then be provided both to select either the first, second, or neither avatar to become her current avatar.

At block 508, process 500 can build an avatar with the obtained avatar features according to the determined priority. For example, each avatar feature can be defined for a particular place on an avatar model and process 500 can build the avatar by adding each avatar feature to its corresponding place. After building the avatar (and in some cases providing additional options for user customizations or approval), process 500 can end.

FIG. 6 is a flow diagram illustrating a process 600 used in some implementations of the present technology for extracting avatar features based on an image source. In some implementations, process 600 can be performed as a sub-process of process 500, e.g., at block 502. In some cases, process 600 can be performed periodically, such as daily or when a user starts up her device after a threshold period of inactivity.

At block 602, process 600 can obtain an image of a user. In various cases, the image can be taken by the user on the device performing process 600 (e.g., as a “selfie,” can be uploaded by the user to process 600 from another device, can be captured by the device performing process 600 from another process—e.g., an image stored from a recent user interaction such as a social media post, video call, holographic call, etc.)

At block 604, process 600 can analyze the image of the user to identify avatar features that match available types of avatar characteristics in an avatar library. The avatar features can be determined as semantic identifiers with characteristics for an avatar (e.g., hair, accessories, clothing options, etc.) such as “red shirt,” “straight, blond hair,” “Dodger's hat,” “handlebar mustache,” “round glasses,” “locket necklace,” etc. The semantic identifiers can be identified by a machine learning model and using a set of avatar feature types available in an avatar library.

As one example, a machine learning model trained for object and feature recognition can be applied to the image to identify features, and then those features can be filtered to select those that match categories of items in the avatar library. As a more specific instance of this example, the machine learning model can perform object recognition to return “hoop earrings” based on its analysis of an image. This semantic identifier can be matched to a category of avatar features of “jewelry->earrings” in the avatar library, and thus can be used to select a closest matching avatar feature from that category. If no category matched the machine learning result, the result could be discarded.

As a second example, a machine learning model trained to identify objects and styles that are within the avatar library. For example, the model could be trained with training items that pair image inputs with identifiers from the avatar library. The model can then be trained to identify such semantic identifiers from new images. See additional details below, following the description of FIG. 12, illustrating example types of machine learning models and training procedures that can be used. Thus, when the machine learning model receives an image, it performs the object and style recognition to return semantic identifiers that are in the avatar library. In some cases, the machine learning model may provide these results as a value that can also be used as a confidence factor for the result, and if the confidence factor is below a threshold, the result could be discarded.

In some cases, process 600 can first analyze the image to recognize object and/or styles matching categories in the avatar library (e.g., shirt, glasses, hair) and then may analyze the portion of the image where each feature is depicted to determine the characteristic(s) of that feature (e.g., color, size/shape, style, brand, etc.) Thus, process 600 can identify a portion of the image from which that image semantic identifier was generated and analyze the portion of the image where that image semantic identifier was identified to determine one or more characteristics associated with that image semantic identifier.

At block 606, process 600 can return the avatar features identified in block 604. Process 600 can then end.

FIG. 7 is a flow diagram illustrating a process 700 used in some implementations of the present technology for extracting avatar features based on an online context source. In some implementations, process 700 can be performed as a sub-process of process 500, e.g., at block 502. In some cases, process 700 can be performed periodically, such as daily, or when a new online activity defied for avatar updating is identified.

At block 702, process 700 can obtain online contextual information for a user. In various implementations, the online contextual information can include user activities such as purchasing an item, performing a social media “like,” posting to social media, adding an event RSVP or location check-in, joining an interest group, etc. In some implementations, this can be only those online activities that the user has authorized to be gathered.

At block 704, process 700 can analyze the online contextual information for the user to identify avatar features that match available types of avatar characteristics in an avatar library. In some implementations, process 700 can identify avatar features from a user's online context by determining a type for various of the online activities defined in the context (e.g., shopping items, social media “likes” and posts, event RSVPs, location check-ins, etc.) and can use a process to extract corresponding avatar features mapped to each type. For example, a shopping item can be mapped to selecting a picture of a purchased shopping item, identifying a corresponding textual description of the purchased shopping item, determining associated meta-data and finding a closest matching avatar feature in the avatar library (e.g., by applying a machine learning model as described for FIG. 6 to the associated image or by applying an NLP analysis described for FIG. 8 for the textual or meta-data); an event RSVP can be mapped to selecting accessories matching the event (e.g., selecting a sports cap matching a team for an RSVP to a sporting event, selecting opera glasses for a trip to the opera, selecting a balloon for a trip to the fair, etc.), a like on a social media post can be mapped to extracting features of the persons depicted (e.g., matching makeup style) and/or to extracting objects depicted (e.g., selecting an avatar feature from the avatar library best matching a depicted pair of shoes in a social media post); etc.

At block 706, process 700 can return the avatar features identified at block 704. Process 700 can then end.

FIG. 8 is a flow diagram illustrating a process 800 used in some implementations of the present technology for extracting avatar features based on a textual source. In some implementations, process 800 can be performed as a sub-process of process 500, e.g., at block 502. In some cases, process 800 can be performed in response to a user command (e.g., entering an interface for typing an avatar description or speaking a phrase such as “update my avatar to . . . ”) to an automated agent. At block 802, process 800 can obtain a textual description of avatar features, e.g., from the user typing into the input field or speaking a phrase which is then transcribed.

At block 804, process 800 can analyze the textual description to identify avatar features that match available types of avatar characteristics in an avatar library. Process 800 can identify the avatar features from the textual description by applying one or more natural language processing (NLP) models and/or algorithms to the user-supplied textual description. This can include applying machine learning models trained and/or algorithms configured to, e.g., perform parts-of-speech tagging and identify n-grams that correspond to avatar features defined in the avatar library. For example, process 800 can identify certain nouns or noun phrases corresponding to avatar features such as hair, shirt, hat, etc. and can identify modifying phrases such as big, cowboy, blue, curly, etc. that correspond to the identified noun phrases and that match characteristics that can be applied to the identified avatar features.

At block 806, process 800 can return the avatar features identified at block 804. Process 800 can then end.

FIGS. 9A-9C are conceptual diagrams illustrating examples 900, 940, and 970 of user interfaces and results of automatic avatar creation based on an image. In example 900, a user has started an application on her smartphone 902 in which she is represented as an avatar. This is the first time this application has been executed this day, so it provides a prompts 904 with an option to take a selfie to update her avatar. If the user selects control 906, she is taken to example 940. In example 940, a user has selected control 906 and is taking the selfie image 942 (e.g., by pressing control 944 on smartphone 902). Once this image is captured, the automatic avatar system extracts avatar features such as curly dark hair, black glasses, and tank top shirt. In example 970, an avatar 972 with these avatar features has been created, using matching avatar features obtained from an avatar library, including curly dark hair 974, glasses 976 which have been set to black, and a tank top 978. The user is offered the confirm button 980, which if selected, will update the avatar of the user to the avatar 972.

FIG. 10 is a conceptual diagram illustrating an example 1000 of automatic avatar creation based on an online context. In example 1000, an online context of a user having purchased a red crop-top shirt 1002 has been identified. In response, the automatic avatar system has matched an image of the purchased crop-top shirt 1002 to a shirt 1004 and has applied a similar red color, identified from the image, to the shirt 1004. The automatic avatar system has also provided a notification 1006 to the user, informing her of an option to have her avatar updated to conform to her purchase. If the user selects confirm button 1008, the automatic avatar system will update the avatar of the user to be wearing the red shirt 1004.

FIG. 11 is a conceptual diagram illustrating an example 1110 of automatic avatar creation based on text. In example 1100, the automatic avatar system has determined that the user has an upcoming event, which is a trigger for offering to update the user's avatar. Thus, the automatic avatar system provides notification 1102 with the option. In response, the user speaks phrase 1104 with a description of how to update her avatar, including to add a “baseball hat” to it. The automatic avatar system has transcribed this input, identified the “hat” avatar feature and the “baseball” characteristic for the hat, and has matched these to a hat 1106 from an avatar library. The automatic avatar system has also provided a notification 1108 to the user, informing her of an option to have her avatar updated to have the hat she requested. If the user selects confirm button 1110, the automatic avatar system will update the avatar of the user to be wearing the baseball hat 1106.

FIG. 12 is a system diagram illustrating an example system 1200 for automatically creating an avatar from an image, context, and text. In example 1200, three sources have been gathered as a basis for selecting avatar features: online context 1202, image 1204, and text 1206 (in other examples only one or two sources are used at a given time). The online context 1202 includes data about a user's online activity (which the user has authorized use for selecting avatar features) such as on a social media site, online shopping, search data, etc. The image 1204 is an image of the user such as a selfie taken to select avatar features or from a previous image captured of the user which the user has authorized for this purpose. The text 1206 is a textual description of one or more avatar features provided by the user.

Each of these sources is passed to extract features module 1208, which uses defined extraction features for types of online content to identify avatar features from the context 1202, uses a machine learning image analysis model to extract avatar features from the image 1204, and uses a machine learning natural language processing model to extract avatar features from the text 1206. Together these features are the extracted features 1210. Where there are conflicts among the types of the extracted features 1210, the extracted features 1210 can be ranked (e.g., based on source type, through user selection, and/or based on confidence factors) to select a set of avatar features that can all be applied to an avatar.

The extract features module 1208 also extracts characteristics 1212 for the identified avatar features 1210. These can be based on a defined set of characteristics that an avatar feature can have. For example, a “shirt” avatar feature can have a defined characteristic of “color” and a “hair” avatar feature can have defined characteristics of “color” and “style.”

The avatar features and characteristic definitions 1210 and 1212 can be provided to construct avatar module 1214, which can select best-matching avatar features from avatar library 1216. For example, construct avatar module 1214 can use a model trained to map such avatar features into a semantic space of the avatar library and select closest (e.g., lowest cosine distance) avatar feature from the library also mapped into the semantic space. In various cases, the construct avatar module 1214 can select avatar features from the avatar library that are created with the corresponding characteristics 1212 or can set parameters of the obtained avatar features according to the characteristics 1212. With the correct avatar features obtained, having the correct characteristics, the construct avatar module 1214 can generate a resulting avatar 1218.

A “machine learning model,” as used herein, refers to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include: neural networks, support vector machines, decision trees, Parzen windows, Bayes, clustering, reinforcement learning, probability distributions, decision trees, decision tree forests, and others. Models can be configured for various situations, data types, sources, and output formats. As an example, a machine learning model to identify avatar features can be a neural network with multiple input nodes that receives, e.g., a representation of an image (e.g., histogram). The input nodes can correspond to functions that receive the input and produce results. These results can be provided to one or more levels of intermediate nodes that each produce further results based on a combination of lower level node results. Trained weighting factors can be applied to the output of each node before the result is passed to the next layer node. At a final layer, (“the output layer,”) one or more nodes can produce a value classifying the input that, once the model is trained, can be used as an avatar feature. In some implementations, such neural networks, known as deep neural networks, can have multiple layers of intermediate nodes with different configurations, can be a combination of models that receive different parts of the input and/or input from other parts of the deep neural network, or are convolutions or recurrent—partially using output from previous iterations of applying the model as further input to produce results for the current input. In some cases, such a machine learning model can be trained with supervised learning, where the training data includes images, online context data, or a textual description of avatar features as input and a desired output, such as avatar features available in an avatar library. In training, output from the model can be compared to the desired output for that image, context, or textual description and, based on the comparison, the model can be modified, such as by changing weights between nodes of the neural network or parameters of the functions used at each node in the neural network (e.g., applying a loss function). After applying each of the avatar source inputs in the training data and modifying the model in this manner, the model can be trained to evaluate new images, online contexts, or textual descriptions to produce avatar feature identifiers.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for automatically generating an avatar, the method comprising:
automatically obtaining avatar features based on one or more sources by:
using an image source, including:
obtaining an image of a user;
applying one or more machine learning models to a representation of the image of the user to generate image semantic identifiers corresponding to avatar features in an avatar library; and
selecting, from the avatar library, avatar features matching the generated image semantic identifiers;
using an online context source, including:
obtaining data indicating one or more online activities of the user;
determining a type of an online activity of the one or more online activities;
determining a context semantic identifier extraction method mapped to the determined type;
applying the context semantic identifier extraction method to the online activity to obtain one or more context semantic identifiers; and
selecting, from the avatar library, avatar features matching the context semantic identifiers; or
using a textual description source, including:
obtaining a textual description for an avatar;
identifying one or more textual semantic identifiers by applying natural language processing on the textual description to extract n-grams that correspond to avatar features defined in the avatar library; and
selecting, from the avatar library, avatar features matching the context semantic identifiers;
determining a conflict among two or more of the avatar features and, in response, removing all but one of the two or more of the avatar features, from the obtained avatar features, based on a determined priority ordering; and
constructing an avatar with the obtained avatar features.

2. The method of claim 1, wherein the automatically obtaining the avatar features includes the using the image source.

3. The method of claim 2 further comprising identifying characteristics for one or more of the avatar features by, for one or more of the image semantic identifiers:
identifying a portion of the image from which that image semantic identifier was generated; and
analyzing the portion of the image where that image semantic identifier was identified to determine one or more characteristics associated with that image semantic identifier.

4. The method of claim 1, wherein the automatically obtaining the avatar features includes the using the online context source.

5. The method of claim 4,
wherein the type of the online activity corresponds to a shopping activity and wherein the method mapped to the shopping activity includes selecting, as a context semantic identifier, a semantic identifier based on a picture associated with an item purchased via the shopping activity;
wherein the type of the online activity corresponds to an event RSVP activity and wherein the method mapped to the event RSVP activity includes selecting a semantic identifier based on one or more accessories defined for the event; or
wherein the type of the online activity corresponds to a social media activity and wherein the method mapped to the social media activity includes identifying features of one or more persons depicted in relation to the social media activity as a semantic identifier and/or identifying one or more objects depicted in relation to the social media activity as a semantic identifier.

6. The method of claim 1, wherein the automatically obtaining the avatar features includes the using the textual description source.

7. The method of claim 6, wherein the extracting n-grams includes identifying nouns or noun phrases determined to correspond to avatar features.

8. The method of claim 6, wherein the applying natural language processing includes applying a parts-of-speech tagger to classify parts of the textual description for the avatar.

9. The method of claim 6 further comprising identifying modifying phrases that correspond to the extracted n-grams and that match characteristics that can be applied to the corresponding avatar features.

10. The method of claim 1,
wherein the automatically obtaining the avatar features includes the using the image source; and
wherein at least one of the one or more machine learning models is trained, to identify objects and styles that are within the avatar library, using training items that pair image-based inputs with identifiers from the avatar library.

11. The method of claim 1, wherein the determined priority ordering is determined according to a ranking among the one or more sources from which each avatar feature is obtained.

12. The method of claim 1, wherein the automatically obtained avatar features do not include at least one avatar feature identified as necessary for the constructing the avatar and, in response, the constructing the avatar comprises selecting the at least one avatar feature from a default set of avatar features specified by the user.

13. A computer-readable storage medium storing instructions that, when executed by a computing system, cause the computing system to perform a process for automatically generating an avatar, the process comprising:
automatically obtaining avatar features, using an image source, including:
obtaining an image of a user;
applying one or more machine learning models to a representation of the image of the user to generated image semantic identifiers corresponding to avatar features in an avatar library; and
selecting, from the avatar library, avatar features matching the generated image semantic identifiers; and
constructing an avatar with the obtained avatar features.

14. The computer-readable storage medium of claim 13, wherein the process further comprises identifying characteristics for one or more of the avatar features by, for one or more of the image semantic identifiers:
identifying a portion of the image from which that image semantic identifier was generated; and
analyzing the portion of the image where that image semantic identifier was identified to determine one or more characteristics associated with that image semantic identifier.

15. The computer-readable storage medium of claim 13, wherein at least one of the one or more machine learning models is trained, to identify objects and/or styles that are within the avatar library, using training items that pair image-based inputs with identifiers from the avatar library.

16. The computer-readable storage medium of claim 13, wherein the automatically obtained avatar features do not include at least one avatar feature identified as necessary for the constructing the avatar and, in response, the constructing the avatar comprises selecting the at least one avatar feature from a default set of avatar features specified by the user.

17. A computing system for automatically generating an avatar, the computing system comprising:
one or more processors; and
one or more memories storing instructions that, when executed by the one or more processors, cause the computing system to perform a process comprising:
automatically obtaining avatar features based on one or more sources by:
using an image source, including:
obtaining an image of a user;
applying one or more machine learning models to a representation of the image of the user to generate image semantic identifiers corresponding to avatar features in an avatar library; and
selecting, from the avatar library, avatar features matching the generated image semantic identifiers;
using an online context source, including:
obtaining data indicating one or more online activities of the user;
determining a type of an online activity of the one or more online activities;
determining a context semantic identifier extraction method mapped to the determined type;
applying the context semantic identifier extraction method to the online activity to obtain one or more context semantic identifiers; and
selecting, from the avatar library, avatar features matching the context semantic identifiers; or
using a textual description source, including:
obtaining a textual description for an avatar;
identifying one or more textual semantic identifiers by applying natural language processing on the textual description to extract n-grams that correspond to avatar features defined in the avatar library; and
selecting, from the avatar library, avatar features matching the context semantic identifiers; and
constructing an avatar with the obtained avatar features.

18. The computing system of claim 17, wherein the automatically obtaining the avatar features includes the using the image source.

19. The computing system of claim 17, wherein the automatically obtaining the avatar features includes the using the online context source.

20. The computing system of claim 17, wherein the automatically obtaining the avatar features includes the using the textual description source.
